(19) United States
(12) Patent Application Publication
(10) Pub. No.: US 2020/0337409 A1
(43) Pub. Date: Oct. 29, 2020

(54) Multilayer Textile Assembly for Use in Footwear

(71) Applicant: Stedfast Inc., Granby, Québec (CA)

(72) Inventor: Martin FILTEAU, Mont St-Hilaire, Québec, Canada (CA)

(21) Appl. No.: 16/764,857

(22) PCT Filed: Nov. 19, 2018
(86) PCT No.: PCT/CA2018/051469

§ 371 Date: May 16, 2020

Related U.S. Application Data
(60) Provisional application No. 62/587,873, filed on Nov. 17, 2017.

(51) Int. Cl. A43B 1/04; B32B 27/02; B32B 27/08; B32B 37/14; B32B 5/06; A43B 23/02; A43B 3/02; A43B 7/12; A43B 7/34

(52) U.S. Cl. CPC A43B 1/04; D10B 2501/043; B32B 27/08; B32B 37/144; B32B 5/06; A43B 23/022; A43B 23/0235; A43B 3/02; A43B 7/125; A43B 7/34; B32B 2262/0276; B32B 2305/186; B32B 2305/188; B32B 2307/7265; B32B 2437/02; D10B 2201/02; D10B 2201/24; D10B 2211/02; D10B 2321/022; D10B 2331/02; D10B 2331/04; D10B 2403/021; B32B 27/02

(57) ABSTRACT

Here are described multilayer textile assemblies for use in footwear and methods of production thereof. Also described are footwears and boot liners comprising the multilayer textile assemblies.

### TECHNICAL FIELD

The technical field generally relates to the field of textile or fabric technology. More particularly, the invention relates to a multilayer textile assembly for use in footwear.

### BACKGROUND

The present application generally relates to a fabric material for use as a thermal, liquid resistant and water vapor permeable barrier in footwear. More specifically, the present application relates to protective boots for firefighters and military soldiers. Generally, a work boot includes a boot liner, which provides thermal insulation. Traditional textiles used as thermal insulating barriers in boot liners contain a thick non-woven material, such as felts and neoprene. However, this particular type of material functions by trapping air in the textile.

Problematics associated with conventional boot liners include the non-resilient behavior in compression of the fabric or poor resistance to compression. When high compressive strength is applied to a standard boot liner fabric, thermal insulation is reduced due to a loss in air-filled spaces and the thinning down of the fabric when compressed (the non-resilient behavior in compression). It is essential for a boot liner to be compression-resistant as it also significantly affects the comfort of the foot. Conventional work boots also do not provide proper water elimination and water barrier which may also seriously affect foot comfort.

Consequently, some unsolved problems related to the working footwear industry includes the prevention of moisture accumulation, poor moisture-wicking performances, slow drying, the weight, limited comfort, poor thermal properties, poor insulation properties, durability and high cost.

There is therefore a need for an alternative technological approach for protective boots one or more of the above-mentioned issues typically associated with conventional liners.

### SUMMARY

According to one aspect, the present application relates to a multilayer textile assembly for use in a footwear, the multilayer textile assembly comprising, successively:
a first layer comprising a woven or knitted fabric of nylon or polyester or a blend thereof with natural or synthetic fibers;
a second layer comprising a membrane made with a waterproof-breathable material; and
a third layer, comprising:
   an outer fabric sheet and an inner fabric sheet extending in a superposed relationship, each of said inner and outer fabric sheets independently comprising a woven or knitted fabric of nylon or polyester or a blend thereof with natural or synthetic fibers; and
   at least one monofilament yarn connecting the outer and inner fabric sheets and arranged in a pile structure forming an air-filled spacer between said outer and inner fabric sheets.

In one aspect, the layers of the multilayer textile assembly all exclude fire resistant fibers.

In one embodiment, the fabric of the first layer is preferably made with nylon or polyester or a blend thereof with natural or synthetic fibers. In one example, the first layer is typically manufactured by weaving, warp knitting or circular knitting.

In one embodiment, the membrane of the second layer may include a microporous waterproof-breathable material, and may include an expanded polytetrafluoroethylene (ePTFE). The membrane may further be treated or coated on at least one of its sides with a hydrophilic polymer. In one example, the hydrophilic polymer includes polyurethane (PU); for example, copolymers of urethane such as polyether-urethane or polyester-urethane. In another example, the treatment or coating of the hydrophilic polymer onto the membrane may be made by roll coating, film lamination, spraying or dots.

In a further embodiment, the inner and outer fabric sheets of the third layer are preferably made with nylon or polyester or a blend thereof with natural or synthetic fibers. In one example, the fabric sheets are manufactured by weaving, warp knitting or circular knitting.

In a yet further embodiment, the at least one monofilament yarn of the third layer is made with a material similar to the one used in fishing wires. In one example, the monofilament yarn is made with nylon or polyester.

In a further embodiment, the three successive layers of the multilayer textile assembly are linked together. In one implementation, the second layer may be laminated to the first layer and the hydrophilic polymer of the second layer may bind the second layer to the third layer.

According to another aspect, the present application relates to the use of the multilayer textile assembly in footwear including boots, such as work boots, military boots or combat boots. In one variant of interest, the footwear may be a firefighter boot.

In one embodiment, the footwear is a firefighter boot. In one example, the firefighter boot includes a rigid protective shell and a boot liner made with the multilayer textile assembly that fits inside the protective shell. In one example, the multilayer textile assembly is arranged so that its third layer extends on the side of the foot, whereas the first layer extends on a side of the protective shell.

According to another aspect, the present application relates to a footwear comprising a multilayer textile assembly as defined herein.

According to another aspect, the present application relates to a boot liner comprising a multilayer textile assembly as defined herein.

According to a further aspect, the present application relates to a method for producing a multilayer textile assembly for use in a footwear, the method comprising the steps of:
providing a first layer comprising a woven or knitted fabric of nylon or polyester or a blend thereof with natural or synthetic fibers;
laminating a second layer to the first layer, the second layer comprising a membrane made with a waterproof-breathable material which is optionally microporous, and may for example comprise an expanded polytetrafluoroethylene (ePTFE); and
providing a third layer including:
   providing an outer fabric sheet and an inner fabric sheet extending in a superposed relationship, each of said inner and outer fabric sheets independently comprising a woven or knitted fabric of nylon or polyester or a blend thereof with natural or synthetic fibers; and
   connecting the outer and inner fabric sheets with at least one monofilament yarn arranged in a pile structure forming an air-filled spacer between said outer and inner fabric sheets; and
binding the third layer to the second layer.

Other features and advantages of the multilayer textile assembly when used in footwear will be better understood upon reading the embodiments thereof and the related appended drawings.

### BRIEF DESCRIPTION OF THE DRAWINGS

FIG. 1 is a schematic side view of a multilayer textile assembly according to one embodiment.

FIG. 2 is a schematic side view illustrating the third layer of the multilayer textile assembly of FIG. 1.

FIG. 3 is a representation of footwear provided with a liner made with a multilayer textile assembly according to one embodiment.

### DETAILED DESCRIPTION

The following detailed description and examples are illustrative and should not be interpreted as further limiting the scope of protection.

All technical and scientific terms and expressions used herein have the same definitions as those commonly understood by the person skilled in the art when relating to the present technology. The definition of some terms and expressions provided below take precedence over the common meaning given in the literature.

When an interval of values is mentioned in the present application, the lower and upper limits of the interval are, unless otherwise indicated, always included in the definition.

The term “approximately” or the equivalent term “about” as used herein means approximately in the region of, and around. When the term “approximately” or “about” is used in relation to a numerical value, it modifies it, for example, above and below by a variation of 10% in relation to the nominal value. This term may also take into account, for example, the experimental error of a measuring apparatus or rounding.

In accordance with one aspect, there is provided a multilayer textile assembly 10. For instance, the multilayer textile assembly 10 may be used in footwear.

In the context of the present description, the term “footwear” may be generally understood to refer to an apparel or an article of clothing worn on the feet. Non-limiting examples of footwear include boots, such as work boots, military boots or combat boots. Alternatively, the footwear may also be snow boots, sport boots, equestrian boots, hiking boots, ski boots, snowboard boots, pac boots, shoes, athletic shoes, snowshoes, work shoes, boot socks, socks, sandals or insoles. In one variant of interest, the footwear may be a work boot. For instance, the work booth may be a firefighter boot, as presented in more detail below.

The term “textile” as used herein is meant to generally refer to an element manufactured from natural or synthetic (i.e., man-made) fibers or filaments or monofilaments. Non-limiting examples of synthetic fibers or filaments include polyester, polyamide (e.g., Nylon) aramid or meta-aramid (e.g., Kevlar™, technora™, Twaron™, Nomex™, Teijinvonex™, Kermel™ and Hecracron™) Zylon™, polyethylene (PE), polytetrafluoroethylene (ePTFE), polyphenylene sulfide (PPS), polyetheretherketone (PEEK), acrylic, modacrylic, polyurethane (e.g., spandex or Lycra™), oleofin fibers, polylactide fibers (ingeo), metallic fibers (e.g., lurex) and milk or casein protein fibers. Non-limiting examples of natural fibers or filaments include wool, silk, cashmere, hemp, flax (linen), cotton and bamboo fibers. Non-limiting examples of such elements include yarns, threads and fabrics.

Also, the expression “seam sealing” may be understood to refer to the application of seam tape or seam-sealing glue to cover the holes made by the needle in the sewing process in order to substantially maintain the waterproof properties of the textile.

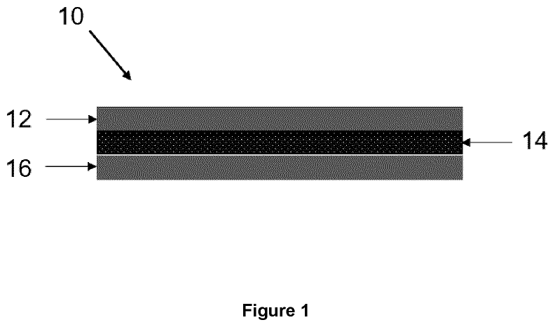

Referring to FIG. 1, a multilayer textile assembly 10 according to one embodiment is schematically illustrated. The multilayer textile assembly 10 includes successively at least three layers. The multilayer textile assembly 10 includes a first layer 12 which is made with a fabric including a material made with fibers, filaments or yarns; provided, however, that the materials exclude fire resistant fibers, filaments or yarns. The fabric of the first layer 12 is typically manufactured by weaving, warp knitting or circular knitting. Alternatively, the fabric of the first layer 12 may also be made with a non-woven material. For example, the fabric material of the first layer 12 may be made with synthetic polyamide fibers such as nylon or synthetic polymer composed of a complex ester such as polyester or a blend thereof with natural or synthetic fibers to obtain blended properties. Natural fibers may include, for example, wool or cotton. For example, the synthetic fibers may include viscose, acetate, acrylic, polyester, polyethylene, polypropylene and polyamide (e.g., nylon). In one variant of interest, the fabric of the first layer 12 may be made with a nylon or a polyester. As mentioned above, the fabric may be made with a blend of nylon or polyester with synthetic or natural fibers; for example, nylon, cotton, polyester, wool, polypropylene and viscose to obtain substantially improved attributes of the materials contained in such a blend. In some implementations, the total weight of the first layer 12 may be within the range of from about 1 to about 2 ounces per square yard (i.e. within the range of from about 33.9 g·m⁻² to about 67.8 g·m⁻²), limits included.

Still referring to the illustrated embodiment of FIG. 1, the multilayer textile assembly 10 further includes a second layer 14. The second layer 14 may be protected by the first layer 12 of the multilayer textile assembly 10. In some implementations, the second layer 14 may include a membrane made with a waterproof-breathable material. The waterproof-breathable material may be microporous, and for example may be made with expanded polytetrafluoroethylene (ePTFE). Alternatively, the second layer 14 may include a membrane made with a non-microporous hydrophilic material (not air permeable or non-breathable). The non-microporous hydrophilic material may, for example, be made with a polymer such as polyester, polyether, polyurethane and their copolymers. Alternatively, the second layer 14 may include a membrane made with a microporous waterproof-breathable polyethylene.

In one implementation, the membrane of the second layer 14 may further be treated or coated on at least one of its sides with a hydrophilic polymer. The hydrophilic polymer may include polyurethane (PU); for example, copolymers of urethane such as a polyether-urethane or a polyester-urethane. The treatment or coating of a hydrophilic polymer onto the membrane may allow for optimal water vapor transfer and protects the membrane from clogging. For example, the treatment or coating of the hydrophilic polymer onto the membrane may be applied by roll coating, film lamination, spraying or dots. The treatment or coating may be applied to the foot-side of the textile, on its opposite side, or both. In one example, the treatment or coating is preferably applied on the foot-side of the textile.

In some implementations, the membrane is made with a microporous waterproof-breathable material that may also be described as a hybrid film that is liquid resistant and water vapor permeable. In other words, the membrane is made with a microporous waterproof-breathable material that provides liquid protection and the transfer of humidity and/or water vapor away from the foot of the wearer of the footwear, resulting in better comfort.

Still referring to the illustrated embodiment of FIG. 1, the multilayer textile assembly 10 further includes a third layer 16.

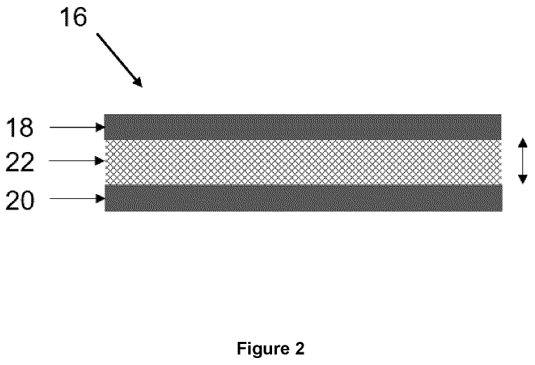

Now referring to the illustrated embodiment of FIG. 2, which shows a schematic side view illustrating the third layer 16. The third layer 16 may include an outer fabric sheet 18 and an inner fabric sheet 20 extending in a superposed relationship. Each of the inner and outer fabric sheets 18 and 20 may include materials made with fibers, filaments or yarns. This is provided however that the materials exclude fire resistant fibers, filaments or yarns. The fabric sheets are typically manufactured by weaving, warp knitting or circular knitting. The fabric sheets are, for example, made with synthetic polyamide fibers such as nylon or synthetic polymers composed of a complex ester, such as polyester, or a blend thereof, with natural or synthetic fibers to obtain blended properties. Natural fibers may include, for example, wool or cotton. For example, the synthetic fibers may include viscose, acetate, acrylic, polyester, polyethylene, polypropylene and polyamide (e.g., nylon). As mentioned above, the fabric sheets may be made with a blend of nylon or polyester and with synthetic or natural fibers. The blend may include a combination of nylon or polyester with other synthetic or natural fibers or polymers such as cotton, wool, polypropylene and viscose.

Still referring to the illustrated embodiment of FIG. 2, the third layer 16 may further include at least one monofilament yarn 22 connecting the outer and inner fabric sheets 18 and 20. Although the description below mostly refers to the monofilament yarn in the singular, it will be readily understood that in some implementations more than one strand of monofilament yarn may be used to connect the inner and outer fabric sheets without departing from the scope of the invention.

As its name would suggest, the monofilament yarn 22 is made with one filament that runs the entire length of the yarn. The monofilament yarn 22 may, for example, be made with synthetic polyamide monofilaments such as nylon or monofilaments of synthetic polymer composed of a complex ester such as polyester. For example, the monofilament yarn 22 may be made with a material that is similar to the one used in fishing wires. Alternatively, the monofilament yarn 22 may be made with nylon 610, nylon 612, or polyester, polyethylene and polypropylene.

In the illustrated embodiment of FIG. 2, the monofilament yarn 22 is arranged in a pile structure forming an air-filled spacer between the outer and inner fabric sheets 18 and 20. The production of this pile structure includes superposing the outer and inner fabric sheets 18 and 20 and connecting them together at a multitude of points over their entire surfaces with the monofilament yarn 22 using a method resembling that of manufacturing double piece velvet weaving. However, unlike the manufacture of double piece velvet weaving, the outer and inner fabric sheets 18 and 20 are not separated after their manufacture to produce two textiles but may rather be used uncut. The “piles” created in this manner may therefore remain connected to both fabric sheets.

In one implementation, the monofilament yarn 22 may be made with a material selected for its low absorbency, improved compressive strength and improved resilience. The thickness of the third layer 16, including the air-filled spacer, may vary from about 1 to about 7 mm, or from 3 to 4 mm depending on the required thermal insulation for the footwear. Indeed, the thickness of the third layer 16 affects thermal insulation as well as comfort and moisture dissipation properties.

As mentioned above, the monofilament yarn 22 is arranged in a pile structure forming an air-filled spacer between said outer and inner fabric sheets 18 and 20. In one implementation, the air-filled spacer may provide a resilient behavior in compression (resistance to compression or compressive strength) of the multilayer textile assembly 10. Furthermore, the air-filled spacer directly influences the thermal insulation but also quick transfer of water vapor away from the foot.

Advantageously, the use of the multilayer textile assembly 10 as described herein in a footwear may provide substantially superior thermal comfort and moisture dissipation properties when compared with current commercial products made with non-woven material such as felts and neoprene. In one aspect, thermal comfort properties may be attributed to the air-filled spacer which entraps air resulting in substantially improved thermal insulation. The resilient behavior of the air-filled spacer may substantially prevent the air-filled spacer to flatten under compressive strength and thus may substantially prevent the thermal insulation to be decreased due to the loss of air-filled spaces. The improved thermal insulation may substantially improve the warmth and comfort of the foot. The moisture dissipation properties may be obtained through several processes. Furthermore, the water resulting from the body heat or sweat is spread by capillarity through the air-filled spacer of the third layer 16 due to surface tension. In another aspect, the membrane of the second layer 14 may include micropores that are large enough to allow water vapor to escape but small enough to substantially prevent liquid water from the environment to penetrate the boot and ultimately reach its wearer's foot. Also, the treatment or coating of hydrophilic polymer onto the membrane may also allow an optimal water vapor transfer. Furthermore, the treatment or coating of hydrophilic polymer onto the membrane also protects the membrane from clogging and thus allows for the membrane to retain its waterproof properties.

Furthermore, the resilient behavior in compression which may be provided by the third layer 16, may also substantially improve the comfort; for example, by substantially minimizing foot fatigue and stress. Such advantages may be of particular interest in specialized footwear, such as work boots such as firefighter boots.

When referring back to FIG. 1, the three successive layers of the multilayer textile assembly 10 may be linked together. In one implementation, the second layer 14 may be laminated to a foot-side surface of the first layer (12). The expression laminated may be understood to refer to the preparation of a membrane that may then be superposed to a textile which may then be firmly attached together by bonding or impregnating and compressing under heat. Advantageously, the hydrophilic polymer of the second layer 14 may bind the second layer to the third layer 16. The multilayer textile assembly 10 may therefore form a monolithic structure without the need for stitches.

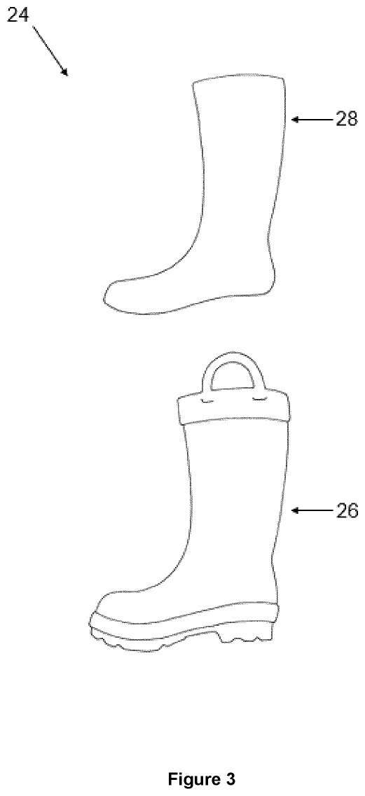

Referring to FIG. 3, there is shown an example of a footwear 24 provided with a multilayer textile assembly 10 according to one implementation. In the illustrated example, the footwear is a firefighter boot. Illustratively, the firefighter boot includes a rigid protective shell 26 which may for example be made with or include rubber or leather and may give shape to the firefighter boot. In the illustrated example, the firefighter boot further includes a boot liner 28 that fit inside the protective shell. The boot liners may be removable from the footwear or permanently attached, sewn or sealed to it.

The boot liner 28 is preferably made with a multilayer textile assembly 10 according to one embodiment described above, in whole or in part. The multilayer textile assembly 10 is arranged such that its third layer 16 extends on the foot side, whereas the first layer 12 extends on the side of the protective shell. In one implementation, the boot liner 28 may be assembled by sewing the boot liner's parts together. The stitch lines of the boot liner 28 may be made substantially leak proof, for example, by seam sealing.

Another advantage of the third layer 16 is its substantially lower drying time when used either as a fixed, non-removable liner or as a removable liner, especially when compared to boot liners made with nonwoven fabrics, felts and neoprene.

The thickness of the multilayer textile assembly 10 may vary depending on the different regions of the boot liner. In one embodiment, a thinner and lighter air-filled spacer may be provided for the upper part of the footwear, and a thicker and heavier air-filled spacer may be provided under the foot or sole to substantially improve the comfort and substantially minimize fatigue and stress of the foot. The footwear as described herein thereby providing many benefits. For example, thermal comfort is a feature of embodiments of the multilayer textile assembly 10 as described herein. Other benefits may include comfort properties such as the sensation of dryness and heat and moisture transference (water vapor transfer), low cost, durability, resilience, weight and comfort. The multilayer textile assembly 10 may significantly improve the comfort of workers when compared to boot liners made with non-wovens, felts and neoprene. Other advantages may include the flexibility of the multilayer textile assembly 10 especially for the upper part of the boot. This improved flexibility may provide improved mobility and ease of movements such as knee flexing and ankle rotation. The improved mobility may result in lower time for donning and doffing, and therefore may reduce the energy required for such operations.

Once again, numerous modifications could be made to the embodiments above without departing from the scope of the invention.

1. A multilayer textile assembly for use in a footwear, the multilayer textile assembly comprising, successively:
a first layer comprising a woven or knitted fabric of nylon or polyester or a blend thereof with natural or synthetic fibers;
a second layer comprising a membrane made with a waterproof-breathable material; and
a third layer, comprising:
an outer fabric sheet and an inner fabric sheet extending in a superposed relationship, each of said inner and outer fabric sheets independently comprising a woven or knitted fabric of nylon or polyester or a blend thereof with natural or synthetic fibers; and
at least one monofilament yarn connecting the outer and inner fabric sheets and arranged in a pile structure forming an air-filled spacer between said outer and inner fabric sheets.

2. (canceled)

3. The multilayer textile assembly of claim 1, wherein the woven or knitted fabrics of the first and third layers independently comprise a material made with fibers, filaments or yarns, said material being selected from a group consisting of nylon fibers, a blend of nylon fibers, natural fibers, a blend of nylon fibers with synthetic fibers, a blend of nylon fibers with natural fibers, polyester fibers, a blend of polyester fibers with natural fibers, and a blend of polyester fibers with synthetic fibers.

4. The multilayer textile assembly of claim 1, wherein the natural or synthetic fibers of the woven or knitted fabrics of the first and third layers are independently selected from the group consisting of wool, cotton, viscose, acetate, acrylic, polyester, polyethylene, polypropylene and polyamide.

5-6. (canceled)

7. The multilayer textile assembly of claim 1, wherein a total weight of the first layer is within the range of from about 1 to about 2 ounces per square yard, limits included.

8. The multilayer textile assembly of claim 1, wherein the waterproof-breathable material of the membrane of the second layer is microporous.

9. (canceled)

10. The multilayer textile assembly of claim 1, wherein the membrane of the second layer is treated or coated on at least one side with a hydrophilic polymer, said at least one side of the membrane being a foot-side or a side opposite the foot side.

11-13. (canceled)

14. The multilayer textile assembly of claim 10, wherein the hydrophilic polymer comprises a polyurethane or a copolymer of urethane selected from a polyether-urethane and a polyester-urethane.

15-18. (canceled)

19. The multilayer textile assembly of claim 1, wherein the at least one monofilament yarn of the third layer comprises nylon or polyester.

20-21. (canceled)

22. The multilayer textile assembly of claim 1, wherein the second layer is laminated to the first layer.

23. The multilayer textile assembly of claim 10, wherein the hydrophilic polymer binds the second layer to the third layer.

24. A footwear comprising a multilayer textile assembly as defined in claim 1, wherein said footwear is selected from a group consisting of boots, shoes, athletic shoes, snowshoes, work shoes, boot socks, socks, sandals and insoles.

25-28. (canceled)

29. The footwear of claim 24, wherein the footwear comprises a rigid protective shell and a liner comprising the multilayer textile assembly, the liner fitting inside the rigid protective shell and being either removable from the rigid protective shell or permanently attached to the rigid protective shell.

30-35. (canceled)

36. The footwear of claim 29, wherein the third layer of the multilayer textile assembly extends on a foot side and the first layer of the multilayer textile assembly extends on a side of the protective shell.

37. (canceled)

38. The footwear of claim 29,
wherein a thickness of the multilayer textile assembly is different along different regions of the liner; and
wherein the air-filled spacer is thinner for an upper part of the footwear, thicker under the foot, or both thinner for the upper part of the footwear and thicker under the foot.

39-40. (canceled)

41. A boot liner comprising a multilayer textile assembly as defined in claim 1, wherein the third layer of the multilayer textile assembly extends on a foot side and the first layer of the multilayer textile assembly extends on a side opposite the foot side.

42. (canceled)

43. The boot liner of claim 41, wherein the boot liner comprises boot liner's parts, and Is assembled by sewing the boot liner's parts together.

44-46. (canceled)

47. The boot liner of claim 41,
wherein a thickness of the multilayer textile assembly is different along different regions of the boot liner; and
wherein the air-filled spacer is thinner for an upper part of the footwear, thicker under the foot, or both thinner for the upper part of the footwear and thicker under the foot.

48-49. (canceled)

50. A method for producing a multilayer textile assembly for use in a footwear, the method comprising the steps of:
providing a first layer comprising a woven or knitted fabric of nylon or polyester or a blend thereof with natural or synthetic fibers;
laminating a second layer to the first layer, the second layer comprising a membrane made with a waterproof-breathable material;
providing a third layer, the step of providing a third layer comprising:
providing an outer fabric sheet and an inner fabric sheet extending in a superposed relationship, each of said inner and outer fabric sheets independently comprising a woven or knitted fabric of nylon or polyester or a blend thereof with natural or synthetic fibers; and
connecting the outer and inner fabric sheets with at least one monofilament yarn arranged in a pile structure forming an air-filled spacer between said outer and inner fabric sheets; and
binding the third layer to the second layer.

51. The method of claim 50, wherein the steps of providing a first layer and of providing an outer fabric sheet and an Inner fabric sheet individually include manufacturing the woven or knitted fabrics by weaving, warp knitting or circular knitting.

52. (canceled)

53. The method of claim 50, wherein the step of connecting the outer and inner fabric sheets includes superposing the outer and inner fabric sheets and connecting them together at a multitude of points over their entire surfaces with the monofilament yarn.

54. The method of claim 50, wherein the waterproof-breathable material of the membrane of the second layer is microporous.

55. (canceled)

56. The method of claim 50, further comprising treating or coating the membrane of the second layer on at least one its side with a hydrophilic polymer, wherein the treating or coating is performed by roll coating, film lamination, spray or dots.

57. (canceled)

58. The method of claim 50, wherein the laminating is performed by bonding or impregnating and compressing under heat.
